(19) United States
(12) Patent Application Publication
(10) Pub. No.: US 2024/0375017 A1
(43) Pub. Date: Nov. 14, 2024

(54) METHOD AND SYSTEM FOR MULTI-MODAL GAME PLATFORM INTEGRATIONS

(71) Applicant: WIZARDS OF THE COAST LLC, Renton, WA (US)

(72) Inventors: Chris Cao, Auburn, WA (US); Andrew Jordan, Orlando, FL (US); Kale Stutzman, Bainbridge Island, WA (US)

(21) Appl. No.: 18/657,596

(22) Filed: May 7, 2024

Related U.S. Application Data
(60) Provisional application No. 63/464,918, filed on May 8, 2023.

(51) Int. Cl. A63F 13/80; A63F 13/352; G06F 40/284

(52) U.S. Cl. CPC A63F 13/80; A63F 13/352; G06F 40/284

(57) ABSTRACT

A game platform program that enables users to play tabletop games using computer assistance for both the processing of the cognitive load of the game and presentation graphics. The game platform enables play between remote participants, saves game states, and enables ingestion of varied rules documents. Through use of the game platform, users are enabled to design game scenarios by assigning game platform graphic, animation, and adjudication assets to input received via user input platforms. User input platforms coordinate and sync with the game platform via shared authentication or handshaking APIs.

### CROSS-REFERENCE TO RELATED APPLICATIONS

This application claims the benefit of U.S. Provisional Patent Application No. 63/464,918, filed May 8, 2023, which is incorporated herein by reference in its entirety.

### BACKGROUND

3D visualizers and play spaces or tabletop simulators are video game programs that are designed to allow users to re-create existing games or create their own games to play with others online. The game typically provides a game engine with numerous premade tabletop game assets like dice, tokens, and cards. Players are expected to know the rules and play them out as given, simply using the simulator as a game board.

Toyetic games are experiences that use toys as game pieces. One such game that spans multiple modal platforms is Skylanders. Players of Skylanders purchase action figures which then subsequently correspond to the same predetermined, pre-attributed and pre-animated character on a video game platform.

Examples of tabletop games include (but are not limited to), Magic: The Gathering, Warhammer 40K and Age of Sigmar, Monopoly, and Betrayal. Various card and other games have electronic counterparts. For example, in Magic Online or Magic Arena, players purchase virtual Magic: The Gathering cards and build online collections. The players use these cards to build decks for play on the respective platforms.

### BRIEF DESCRIPTION OF THE DRAWINGS

FIG. 1 is a block diagram of a multi-platform input sharing topology.

FIG. 2 is a diagram illustrating communication between a simulator and a user input platform.

FIG. 3 is a flowchart illustrating assignment of simulator assets to user input objects.

FIG. 4 is a flowchart illustrating a simulator ingesting a rules engine.

FIG. 5 is a flowchart illustrating automation of dice rolls.

FIG. 6 is a block diagram illustrating an example computer system, in accordance with one or more embodiments.

FIG. 7 is a high-level block diagram illustrating an example AI system, in accordance with one or more embodiments.

### DETAILED DESCRIPTION

Longtime players of in-person gaming seek means to get together in a world where getting together in person is harder than it used to be. That place is a virtual space where players gather their friends wherever they are—on a computer, phone, console, or even in the same room—and play the game they love. Human networks tend to span great distances, and thus remote solutions address long-felt problems in tabletop gaming.

Further, tabletop games can be difficult to cognitively comprehend and process. There is a tension in game complexity between keeping longtime players interested and attracting new players to the game. Experienced players want additional complexity and features to keep the game feeling fresh, whereas a large number of features make a game unapproachable for new players. There is simply too much for them to learn.

Digital and/or virtual platforms can solve or address the tension caused by game complexity. There are often a lot of steps to adjudicate proposed player actions and a significant amount of relatively simple arithmetic. Even simple arithmetic can become a chore and remove players from the game or the moment.

It is not merely a simple matter of placing a calculator next to the player and having the player enter numbers either. Identifying which numbers to even include into the calculator adds to cognitive load. People play many similar games or editions of games that have similar, but nevertheless distinct rulesets. Remembering which rules apply to which piece at which times can be taxing.

While the disclosed system applies to numerous tabletop and toyetic games and could be applied, with appropriate modifications, to improve playability of any other game referenced in this document. Many others unmentioned are equally appropriate after appropriate modifications associated with relevant game rules.

### Presentation Integrations

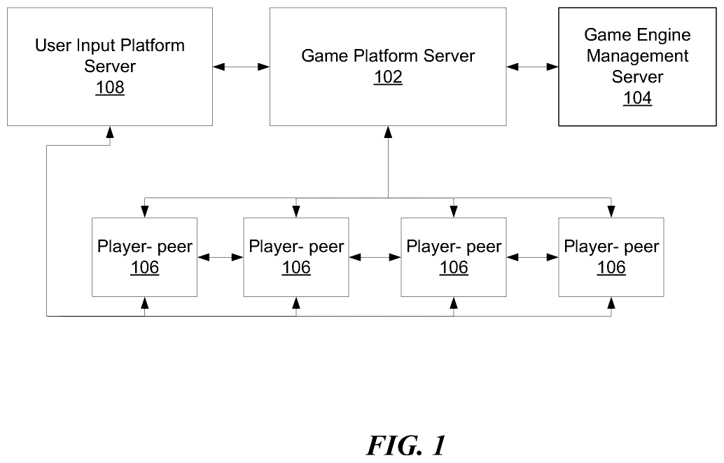

FIG. 1 is a block diagram of a multi-platform input sharing topology. The simulator platform or game platform 102 operates with a graphics engine (e.g., Unreal, Cryo, Unity, or other suitable known game engine). Graphics engines are typically built for versatility and applicability to many gaming contexts including competitive play. To serve the competitive or even semi-competitive environments the game graphics engine operates a game engine management server 104 (operated by Unreal, Cryo, Unity, or other suitable known game engine). The game engine management server 104 performs tasks related to game integrity. Game integrity is upheld via input synchronization (e.g., ordering and timing of the input between individual players) as well object integrity (e.g., a given player avatar moves at a predetermined rate, jumps to a predetermined height, has a hitbox of a predetermined size and shape, has predetermined equipment, etc.)

In the scope of this disclosure, players 106 are given the ability to adjudicate their own games; thus, competitiveness is self-regulated. Thus, players 106 are provided means to bypass or circumvent the integrity features of the game engine management server 104. The game platform 102 has admin access to the instance of the game engine management server 104 that governs games associated with the game platform 102. Through multiple platform user interfaces, the game platform 102 shares significant elements of that admin access to the players 106. As described elsewhere in this application, both the game platform 102 and a separate, independently executing, user input platform 108 enable the user to modify elements present on the game platform 102.

An example user input platform 108 is a rules engine, game piece attributes, or a toy input interface. New graphic models (e.g., new toys), new character attribute blocks, or new game rules to adjudicate (among many other examples) are passed to the game platform server 102 and in turn passed to the game engine management server 104. Similarly, as changes in the game platform 102 are synchronized with the user input platforms 108, the game platform 102 similarly passes data entered directly to the game engine management server 104. The game engine management server 104 maintains the integrity of the game using the user provided data.)

Communication between the game platform 102 and the game engine management server 104 is “legitimate” in that the communication is part of the designed response-request between the game platform 102 and game engine management server 104. The communication is well-formed and not malicious.

The platform empowers a, ‘play your way,’ experience that spans formats from the tabletop, to web, to mobile, to 3D play space. Thus, a focus of the game platform 102 is the platform's ability to take in game or rules data from external/alternate platforms (e.g., user input platform 108) and use the game platform 102 to realize that data. The game engine employed by the game platform 102 is enabled to generate “toys” (e.g., 3D models without animation) based on submitted data. Examples of submitted data include pictures (e.g., of a current tabletop game status). The picture is ingested by the game platform 102 and computer vision techniques are employed to recognize objects in the picture and either link those objects to existing models found within the game platform 102 or generate new “toys” from the available image data.

For example, a player takes a picture of an Optimus Prime action figure and submits that picture via the user input platform 108. The image is passed through to the game platform 102 where the image is recognized, and an in-game model is suggested for use to the player. In some embodiments, the picture input is combined with a rules engine input and the player is enabled to assign the model of Optimus Prime in the game platform 102 a set of attributes corresponding to a Space Marine Dreadnought (e.g., from a Warhammer rules engine).

In another example, a user input platform 108 is embodied as a graphics debugger (e.g., Nvidia Nsight) that rips graphics from frames of a graphics render. 3D wireframes and associated textures are exportable from a captured rendered frame and then importable into the game platform 102. The game platform 102 validates and passes the new “toy” on to the game engine management server 104.

Once imported into the game platform 102, users attach game rules or game piece attributes to any existing toy or newly input toy. The user interface for the game platform 102 enables that attachment. Specifically, as game rules of game piece attributes are imported into the game platform 102 in predefined delineations (e.g., the attributes associated with a single entity are imported as grouped together) the interface enables users to link the predefined delineations to existing or imported “toys.”

In a given example, a group of players are participating in a tabletop game together in person. Many games have very long run times (e.g., several hours). One or more of the users needs to go home and the group decides to load their game into the game platform 102. They proceed to take pictures of their gaming table from a few angles. The game engine stitches those pictures together to create a digital representation (e.g., 2D or 3D as appropriate) of the table and recreates the table in the game platform 102 with all of the physical game pieces as they were. Computer vision techniques recognize toys that already exist as digital models within a user's collection on the game platform 102 and toys that do not have corresponding digital models are linked to existing or new models are generated from the stitched pictures. Now that the tabletop game has been imported into the game platform 102, the players can continue playing the same game at home using the game platform 102.

The simulator is a new platform that builds on existing platforms and tools for play of tabletop games. Integrating platforms and devices upon which those platforms operate streamlines play of the games.

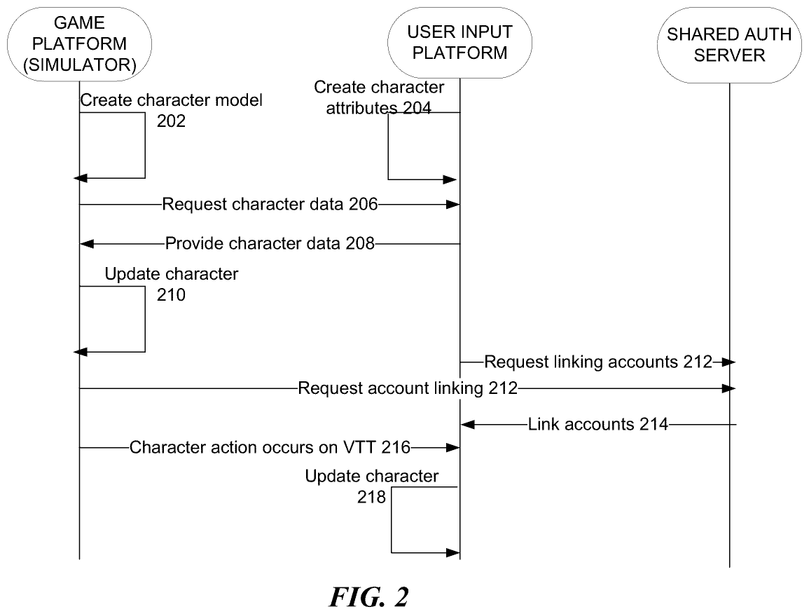

FIG. 2 is a diagram illustrating communication between a simulator and a user input platform. In steps 202 and 204, the respective platforms generate characters. The simulator is more focused on the graphic model and operative attributes relative to executing or adjudicating game rules, whereas the user input platform focuses on descriptive attributes connected to a game rule set.

In step 206, the simulator requests character data from the user input platform. This request occurs when a user attempts to link a given character attribute set to a toyetic model displayed on the simulator. The request seeks to access the data available on the user input platform website. The website that hosts user input platform may be public-under certain settings, anyone with the URL of a character attribute set can link a model in the simulator to the attributes. Thus, in step 208, the website provides the information associated with the attribute set to the simulator.

Notably, while the character attribute sets are configurable as public, editing digital those character attribute sets are not. Once a model has been linked in the simulator, updates to the character attribute sets (e.g., by a logged-in user to the user input platform) update the miniature in the simulator without further authentication. Thus, in step 210, the data associated with the miniature on the simulator is updated based on periodic request and response of data on the character attribute set. However, changes to the non-public toy on the simulator do not inherently cause changes to the public character attribute set.

In step 212, a request is made on either the simulator or the user input platform to link login information of the other respective platform via a shared authentication server. The shared authentication server reconciles logins and enables shared login. Given the proper credentials, in step 214, the shared authentication server links the simulator and user input platform accounts. Then, in step 216, where changes to the character attributes occur on the simulator model, in step 218 the user input platform similarly updates.

The integration of the two platforms enables ease of rules engine management. Synchronization between the two prevents the necessity of users having to “double docket” changes on both platforms. Synchronization further provides some certainty to users that the attributes they are viewing are the most up to date.

Similar to the integration of web platforms, integration of device platforms is similarly available. In some embodiments, the simulator is accessible on a game console, computer, smart TV, or mobile device (smartphone/tablet). The presentation mode on each has different control schemes and visual defaults. For example, presentation on a mobile device is set to a top-down view by default in order to simplify visuals. Users are enabled to change perspective and view from the default.

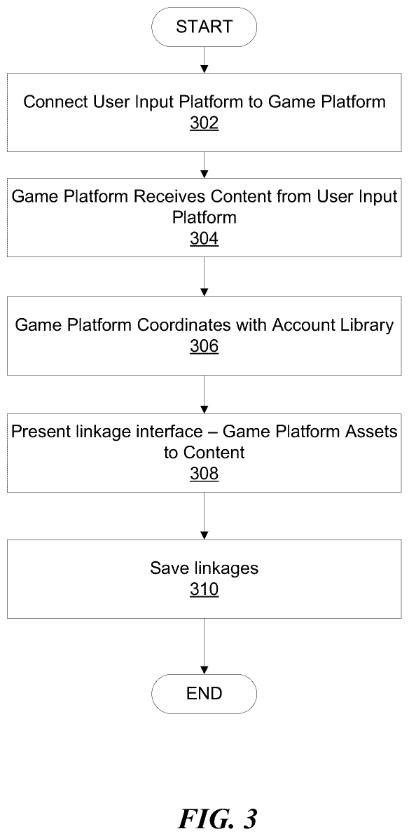

FIG. 3 is a flowchart illustrating assignment of simulator (game platform) assets to user input objects. In step 302, a user input platform is connected to the game platform. Connection thereof includes linking necessary accounts (if applicable) via a shared authentication server or a handshaking API. Where authentication is not required, the game platform is configured to recognize output of the user input platform. Example outputs include image files, text files, save game data, video data, or 3D model files (including any combination of wireframes and/or textures). The game platform is configured to align with the formatting of the output files of a set of predetermined user input interfaces. For example, a set of character attributes that are formatted in a predefined manner connect more readily through the user interface of the game platform.

In step 304, the game platform receives output of the user input platform. In step 306, if applicable, the game platform adds new assets based on the received output to an account library (e.g., new models, new attribute sets). In step 308, the game platform presents a user interface with a set of assets and menus of assignment thereof. The set of assets include elements like models, icons, animations, textures, and game adjudication actions. The player is enabled to assign any or all of the set of assets individual objects from the output of the user input platform. For example, a character or item attribute block constitutes an assignable object. In another illustrative example, a terrain model is linked to an attribute block that indicates the terrain model operates as total cover for other toys positioned there behind. In a third example, a given icon is assigned to a player action described in a rules document.

In step 310, the user saves the assignment of the set of assets to the objects as received from the user input platform. The save is stored in the game platform as a given game file and may be exported as the player choses to other game files.

### Game Attributes and Automation

As described above, the user input platform operates as a means to introduce rules engines to the game platform. Rules engines associate actions available in a given rule set with icons and available simulator actions. Many tabletop games include a number of similar actions that need modelling in the simulator. Examples of these actions including rolling one or more dice, flipping one or more coins, identifying options from a spinner, drawing or manipulating cards, and measuring distance. Using the example of rolling dice to determine outcomes, there are numerous factors that act upon the outcome of those rolls. In some embodiments, the simulator automatically performs checking of the dice rolls against thresholds or requirements, automatically performs subsequent rolls based off results of the first. Any roll by the player that, by game rules, has a predetermined course of follow-up actions may be automated.

Prior to rolling the dice, a number of roll configuration options pre-populate based on the action chosen and, if relevant, the target of the action. In some embodiments, further contextual elements further influence the roll. Pre-population of dice modifiers and automated subsequent rolls are based off a set of pre-programmed rules connected to the game engine and associated with the game being played. Any rule set and available actions are importable to the game platform simulator.

The available same platform actions are triggered based on game rules. Game rules are typically directed by a governing rules document, typically embodied in a text file.

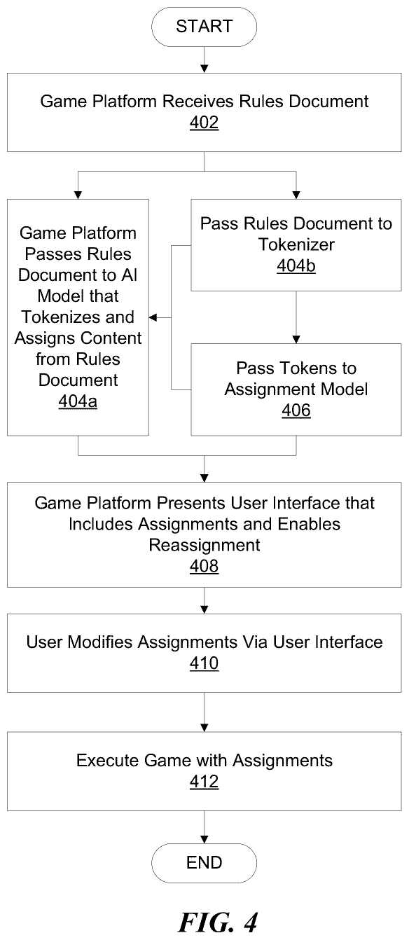

FIG. 4 is a flowchart illustrating a simulator ingesting a rules engine. In step 402, the game platform receives a rules document. The rules document indicates each of the various actions that a player may take during the game, attributes connected to game pieces, and the manner in which to conduct adjudication of game actions. In some embodiments, the rules document is passed to an AI model, such as a generative artificial intelligence (AI) or large language model for interpretation and subsequent attribution of the referenced game actions, game attributes, and game adjudication to various game platform assets. In some embodiments, the rules document is first passed through more specialized models that cause tokenization of the constituent elements of the rules document. These two embodiments are depicted in the figure as adjacent, though they need not be mutually exclusive. Each step could be performed by one or both of such techniques.

In step 404a, the rules document is passed to a generative AI with the command set to identify game actions, attributes, and orders of operation and assign those to assets of the game platform. In step 404b, the rules document is passed to a tokenizer. The tokenizer makes use of natural language processing to identify subsets of the rules document and tokenize those subsets.

In step 406, the game platform passes the tokens to an assignment model that semantically compares the tokens to descriptions of available assets of the game platform and assigns the tokens thereto. Example linkages include connecting a particular dice size to govern the result of a given action; linking a player action described in the rules document as “shoot” with a “ranged attack” asset in the game platform; or linking a set of character attributes from the rules document to a 3D model (a “toy”) of Optimus Prime.

In step 408, the game platform presents users with a user interface that displays the assignments of game platform assets to the rules document tokens. In step 410, the user is enabled to modify the assignments to any other asset in available in the game platform. In step 412, the user is enabled to run a game based on the assignment of the rules document to the assets of the game platform.

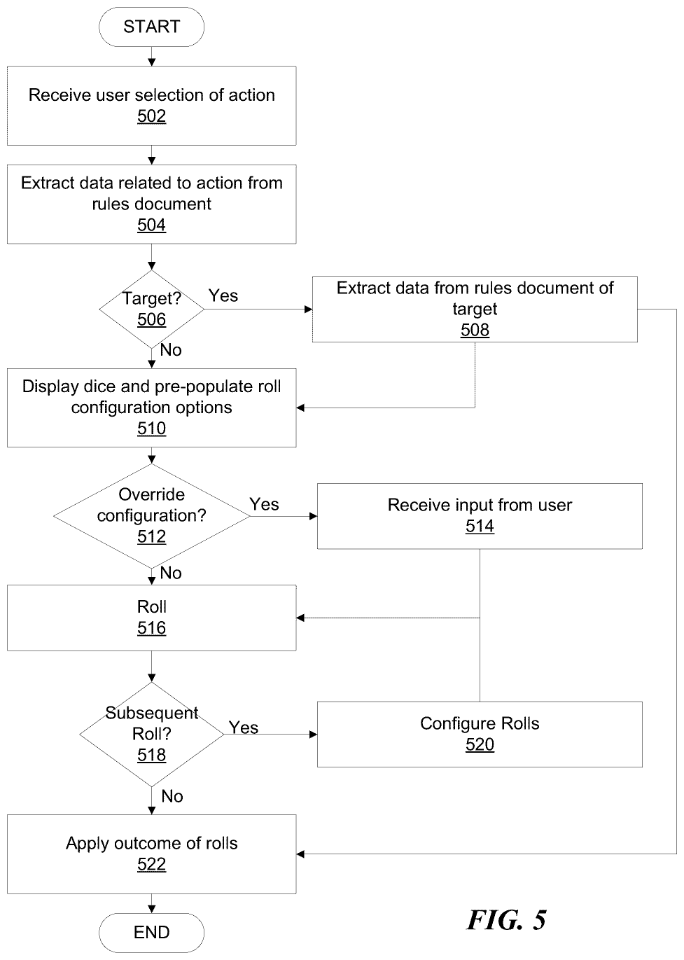

FIG. 5 is a flowchart illustrating automation of dice rolls. Automatic pre-population of dice options reduce cognitive load of players. During live play the scenario may be too complicated or too unique for the simulator to account for. Thus, in that instance, and in stark contrast to traditional video games, the simulator need not impose strict adjudication according to pre-programmed rules.

In step 502, the simulator receives a user-selected action. The actions pertain to a claimed game piece. The game piece is typically selected first to indicate which game piece is performing the action. In step 504, based on the selected action, data pertaining to the action is extracted from a linked rule document.

In step 506, the simulator determines whether the selected action has one or more targets. Where there is a target, in step 508, data pertaining to the target is extracted from a corresponding digital character sheet or stat block. Similarly, in some circumstances, the map context and conditions applied to the target further influence the roll or resolution of the action. The circumstances are predetermined from a set list and include positional elements and/or conditions affecting the target character. Depending on the action, the data extracted from the target character is not used until resolution of the roll as opposed to pre-roll configurations.

In step 510, a digital die is displayed to the user along with pre-populated configuration options based on steps 504-508. The configuration options indicate modifiers and the number of dice to be rolled. In step 512, the user determines whether they will override the pre-populated configuration options. In the course of gameplay, it may be that there is a special circumstance that is not tracked or appreciated by the simulator. Whatever the reason, the user determines whether to override the initial configuration state.

In step 514, where the user has opted to override the initial configuration, the simulator receives additional input from the user via the interface that modifies the configuration of the roll options. In step 516, the user rolls the dice with whichever roll configuration options are currently set. The simulator animates a graphic rolling of dice and depicts a result of the dice face up. All modifiers are applied to the roll.

In step 518, the simulator determines whether subsequent rolls associated with the first roll are required. Where there are additional rolls, in step 520, those rolls are configured. The configuration of the subsequent rolls is based on predetermined options that determine whether the rolls occur automatically or whether the rolls are performed manually.

Once all rolls associated with a given event have occurred, in step 522 the outcome of the rolls is applied to the simulator state. The outcome is based on the action and target(s), and respectively the data extracted in steps 504-508.

### Computing Platform

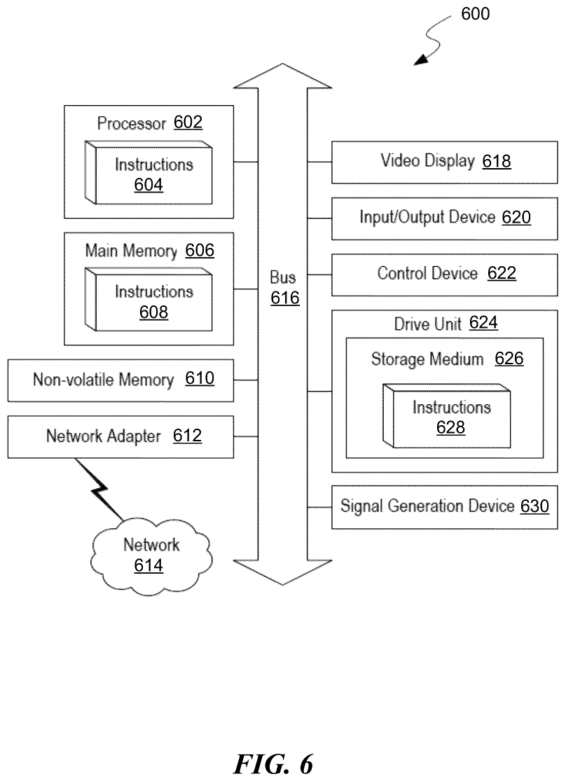

FIG. 6 is a block diagram illustrating an example computer system 600, in accordance with one or more embodiments. In some embodiments, components of the example computer system 600 are used to implement the software platforms described herein. At least some operations described herein can be implemented on the computer system 600.

In some embodiments, the computer system 600 includes one or more central processing units (“processors”) 602, main memory 606, non-volatile memory 610, network adapters 612 (e.g., network interface), video displays 618, input/output devices 620, control devices 622 (e.g., keyboard and pointing devices), drive units 624 including a storage medium 626, and a signal generation device 620 that are communicatively connected to a bus 616. The bus 616 is illustrated as an abstraction that represents one or more physical buses and/or point-to-point connections that are connected by appropriate bridges, adapters, or controllers. The bus 616, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus (also referred to as “Firewire”).

In some embodiments, the computer system 600 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 600.

While the main memory 606, non-volatile memory 610, and storage medium 626 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 628. The term “machine-readable medium” and “storage medium” shall also be taken to include any medium that is capable of storing, encoding, or carrying a set of instructions for execution by the computer system 600. In some embodiments, the non-volatile memory 610 or the storage medium 626 is a non-transitory, computer-readable storage medium storing computer instructions, which is executable by the one or more “processors” 602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in a computer device. When read and executed by the one or more processors 602, the instruction(s) cause the computer system 600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 610, floppy and other removable disks, hard disk drives, optical discs (e.g., compact disc read-only memory (CD-ROMS), digital versatile discs (DVDs)), and transmission-type media such as digital and analog communication links.

The network adapter 612 enables the computer system 600 to mediate data in a network 614 with an entity that is external to the computer system 600 through any communication protocol supported by the computer system 600 and the external entity. The network adapter 612 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 612 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

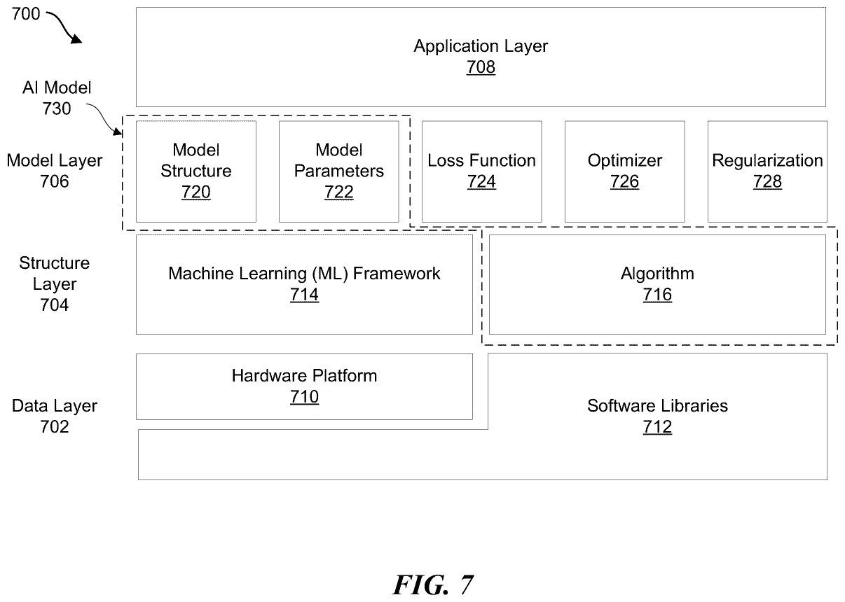

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 700 illustrated and described in more detail with reference to FIG. 7.

### AI System

FIG. 7 is a high-level block diagram illustrating an example AI system, in accordance with one or more embodiments. The AI system 700 is implemented using components of the example computer system 600 illustrated and described in more detail with reference to FIG. 6. Likewise, embodiments of the AI system 700 include different and/or additional components or be connected in different ways.

In some embodiments, as shown in FIG. 7, the AI system 700 includes a set of layers, which conceptually organize elements within an example network topology for the AI system's architecture to implement a particular AI model 730. Generally, an AI model 730 is a computer-executable program implemented by the AI system 700 that analyses data to make predictions. Information passes through each layer of the AI system 700 to generate outputs for the AI model 730. The layers include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for the application of the AI model 730 by the application layer 708.

The data layer 702 acts as the foundation of the AI system 700 by preparing data for the AI model 730. As shown, in some embodiments, the data layer 702 includes two sub-layers: a hardware platform 710 and one or more software libraries 712. The hardware platform 710 is designed to perform operations for the AI model 730 and includes computing resources for storage, memory, logic, and networking, such as the resources described in relation to FIG. 1. The hardware platform 710 processes amounts of data using one or more servers. The servers can perform backend operations such as matrix calculations, parallel calculations, machine learning (ML) training, and the like. Examples of servers used by the hardware platform 710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 710 includes Infrastructure as a Service (IaaS) resources, which are computing resources, (e.g., servers, memory, etc.) offered by a cloud services provider. In some embodiments, the hardware platform 710 includes computer memory for storing data about the AI model 730, application of the AI model 730, and training data for the AI model 730. In some embodiments, the computer memory is a form of random-access memory (RAM), such as dynamic RAM, static RAM, and non-volatile RAM.

In some embodiments, the software libraries 712 are thought of as suites of data and programming code, including executables, used to control the computing resources of the hardware platform 710. In some embodiments, the programming code includes low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource's instruction set architecture, allowing them to run quickly with a small memory footprint. Examples of software libraries 712 that can be included in the AI system 700 include Intel Math Kernel Library, Nvidia cuDNN, Eigen, and Open BLAS.

In some embodiments, the structure layer 704 includes an ML framework 714 and an algorithm 716. The ML framework 714 can be thought of as an interface, library, or tool that allows users to build and deploy the AI model 780. In some embodiments, the ML framework 714 includes an open-source library, an application programming interface (API), a gradient-boosting library, an ensemble method, and/or a deep learning toolkit that works with the layers of the AI system facilitate development of the AI model 730. For example, the ML framework 714 distributes processes for the application or training of the AI model 730 across multiple resources in the hardware platform 710. In some embodiments, the ML framework 714 also includes a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730. Examples of ML frameworks 714 that can be used in the AI system 700 include TensorFlow, PyTorch, Scikit-Learn, Keras, Caffe, LightGBM, Random Forest, and Amazon Web Services.

In some embodiments, the algorithm 716 is an organized set of computer-executable operations used to generate output data from a set of input data and can be described using pseudocode. In some embodiments, the algorithm 716 includes complex code that allows the computing resources to learn from new input data and create new/modified outputs based on what was learned. In some implementations, the algorithm 716 builds the AI model 730 through being trained while running computing resources of the hardware platform 710. The training allows the algorithm 716 to make predictions or decisions without being explicitly programmed to do so. Once trained, the algorithm 716 runs at the computing resources as part of the AI model 730 to make predictions or decisions, improve computing resource performance, or perform tasks. The algorithm 716 is trained using supervised learning, unsupervised learning, semi-supervised learning, and/or reinforcement learning.

The application layer 708 describes how the AI system 700 is used to solve problems or perform tasks. In an example implementation, the application layer 708 includes the response generator 314.

As an example, to train an AI model 730 that is intended to model human language (also referred to as a language model), the data layer 702 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 702 is annotated with ground truth labels (e.g., each data entry in the training dataset is paired with a label), or unlabeled.

Training an AI model 730 generally involves inputting into an AI model 730 (e.g., an untrained ML model) data layer 702 to be processed by the AI model 730, processing the data layer 702 using the AI model 730, collecting the output generated by the AI model 730 (e.g., based on the inputted training data), and comparing the output to a desired set of target values. If the data layer 702 is labeled, the desired target values, in some embodiments, are, e.g., the ground truth labels of the data layer 702. If the data layer 702 is unlabeled, the desired target value is, in some embodiments, a reconstructed (or otherwise processed) version of the corresponding AI model 730 input (e.g., in the case of an autoencoder), or is a measure of some target observable effect on the environment (e.g., in the case of a reinforcement learning agent). The parameters of the AI model 730 are updated based on a difference between the generated output value and the desired target value. For example, if the value outputted by the AI model 730 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 730 typically is to minimize a loss function or maximize a reward function.

In some embodiments, the data layer 702 is a subset of a larger data set. For example, a data set is split into three mutually exclusive subsets: a training set, a validation (or cross-validation) set, and a testing set. The three subsets of data, in some embodiments, are used sequentially during AI model 730 training. For example, the training set is first used to train one or more ML models, each AI model 730, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 730. Backpropagation is used to adjust (also referred to as update) the value of the parameters in the AI model 730, with the goal of optimizing the objective function. For example, a defined loss function is calculated by forward propagation of an input to obtain an output of the AI model 730 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 730 are used. The process of updating (or learning) the parameters over many iterations is referred to as training. In some embodiments, training is carried out iteratively until a convergence condition is met (e.g., a predefined maximum number of iterations has been performed, or the value outputted by the AI model 730 is sufficiently converged with the desired target value), after which the AI model 730 is considered to be sufficiently trained. The values of the learned parameters are then fixed and the AI model 730 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 730 typically involves further training the ML model on a number of data samples (which may be smaller in number/cardinality than those used to train the model initially) that closely target the specific task. For example, an AI model 730 for generating natural language that has been trained generically on publicly available text corpora is, e.g., fine-tuned by further training using specific training samples. In some embodiments, the specific training samples are used to generate language in a certain style or a certain format. For example, the AI model 730 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A method of bypassing competitive game integrity server functionality comprising:
providing a first game platform that includes a rendering of a virtual environment and a first virtual character, the first game platform communicatively connected to:
a second game platform including a user interface that presents modifiable game attributes,
a game integrity server that governs the virtual environment of the first game platform, and
and one or more client users,
wherein the one or more client users are similarly communicatively connected to the second game platform but not the game integrity server;
receiving, by the first game platform from the second game platform, user input originating from the one or more client users that modifies a game attribute associated with a game instance executing via the first game platform and governed by the game integrity server; and
passing the user input from the first game platform to the game integrity server wherein delivery of the user input to the game integrity server is formed as a legitimate communication of game attributes that causes the game integrity server to govern the game instance based on the modification of the game attribute directed by the user input.

2. The method of claim 1, further comprising:
receiving, by the first game platform, a second user input directly from the one or more client users that modifies the game attribute associated with the game instance executing via the first game platform and governed by the game integrity server; and
passing the second user input from the first game platform to the game integrity server wherein delivery of the user input to the game integrity server is formed to be legitimate communication of game attributes that causes the game integrity server to govern the game instance based on the modification of the game attribute directed by the second user input.

3. The method of claim 1, wherein the user input is a text document, the method further comprising:
tokenizing, by the first game platform, subsets of the text document into tokens, including a first token, the tokens indicative of any of object attributes, game actions, or game adjudications; and
attributing the first token to the first virtual character, wherein said attribution causes the first game platform to use the first token in processing of the first virtual character.

4. The method of claim 1, wherein the user input is a text document, the method further comprising:
tokenizing, by the first game platform, subsets of the text document into tokens, including a first token, the tokens indicative of any of object attributes, game actions, or game adjudications; and
attributing the first token to a first element of the game instance, wherein said attribution causes the first game platform to use the first token in adjudicating actions within the game instance.

5. The method of claim 4, wherein either of said tokenizing or attributing is performed by a generative artificial intelligence model.

6. The method of claim 4, further comprising:
providing, by the first game platform, a graphic user interface that enables user selected reattribution of the first token to a different element of the game instance.

7. The method of claim 1, wherein the user input is a virtual character model of a second virtual character, and the modification of the game attribute includes adding the virtual character model of the second virtual character to a library of models introducible into the virtual environment.

8. A system of bypassing competitive game integrity server functionality comprising:
a processor; and
a memory including instructions that when executed cause the processor to:
provide a first game platform and a second game platform that execute independently of one another, wherein the first game platform includes a user interface that presents modifiable game attributes, and the second game platform includes a rendering of a virtual environment and a first virtual character;
receive, by the first game platform, user input from one or more client users that modifies a game attribute associated with a game instance executing via the second game platform and governed by a game integrity server; and
pass the user input from the first game platform to the second game platform and subsequently to the game integrity server wherein delivery of the user input to the game integrity server is formed as a legitimate communication of game attributes that causes the game integrity server to govern the game instance based on the modification of the game attribute directed by the user input.

9. The system of claim 8, the instructions further comprising:
receiving, by the second game platform, a second user input directly from the one or more client users that modifies the game attribute associated with the game instance executing via the second game platform and governed by the game integrity server; and
passing the second user input from the second game platform to the game integrity server wherein delivery of the user input to the game integrity server is formed to be legitimate communication of game attributes that causes the game integrity server to govern the game instance based on the modification of the game attribute directed by the second user input.

10. The system of claim 8, wherein the user input is a text document, the instructions further comprising:
tokenizing, by the second game platform, subsets of the text document into tokens, including a first token, the tokens indicative of any of object attributes, game actions, or game adjudications; and
attributing the first token to the first virtual character, wherein said attribution causes the second game platform to use the first token in processing of the first virtual character.

11. The system of claim 8, wherein the user input is a text document, the instructions further comprising:
tokenizing, by the second game platform, subsets of the text document into tokens, including a first token, the tokens indicative of any of object attributes, game actions, or game adjudications; and
attributing the first token to a first element of the game instance, wherein said attribution causes the second game platform to use the first token in adjudicating actions within the game instance.

12. The system of claim 11, wherein either of said tokenizing or attributing is performed by a generative artificial intelligence model.

13. The system of claim 11, the instructions further comprising:
providing, by the second game platform, a graphic user interface that enables user selected reattribution of the first token to a different element of the game instance.

14. The system of claim 8, wherein the user input is a virtual character model of a second virtual character, and the modification of the game attribute includes adding the virtual character model of the second virtual character to a library of models introducible into the virtual environment.

15. A non-transitory computer-readable medium of bypassing competitive game integrity server functionality, the computer-readable medium contains a plurality of instructions that when executed by a processor cause the processor to:
provide a first game platform and a second game platform that execute independently of one another, wherein the first game platform includes a user interface that presents modifiable game attributes, and the second game platform includes a rendering of a virtual environment and a first virtual character;
receive, by the first game platform, user input from one or more client users that modifies a game attribute associated with a game instance executing via the second game platform and governed by a game integrity server; and
pass the user input from the first game platform to the second game platform and subsequently to the game integrity server wherein delivery of the user input to the game integrity server is formed as a legitimate communication of game attributes that causes the game integrity server to govern the game instance based on the modification of the game attribute directed by the user input.

16. The non-transitory computer-readable medium of claim 15, the instructions further comprising:
receiving, by the second game platform, a second user input directly from the one or more client users that modifies the game attribute associated with the game instance executing via the second game platform and governed by the game integrity server; and
passing the second user input from the second game platform to the game integrity server wherein delivery of the user input to the game integrity server is formed to be legitimate communication of game attributes that causes the game integrity server to govern the game instance based on the modification of the game attribute directed by the second user input.

17. The non-transitory computer-readable medium of claim 15, wherein the user input is a text document, the instructions further comprising:
tokenizing, by the second game platform, subsets of the text document into tokens, including a first token, the tokens indicative of any of object attributes, game actions, or game adjudications; and
attributing the first token to the first virtual character, wherein said attribution causes the second game platform to use the first token in processing of the first virtual character.

18. The non-transitory computer-readable medium of claim 15, wherein the user input is a text document, the instructions further comprising:
tokenizing, by the second game platform, subsets of the text document into tokens, including a first token, the tokens indicative of any of object attributes, game actions, or game adjudications; and
attributing the first token to a first element of the game instance, wherein said attribution causes the second game platform to use the first token in adjudicating actions within the game instance.

19. The non-transitory computer-readable medium of claim 18, wherein either of said tokenizing or attributing is performed by a generative artificial intelligence model.

20. The non-transitory computer-readable medium of claim 18, the instructions further comprising:
providing, by the second game platform, a graphic user interface that enables user selected reattribution of the first token to a different element of the game instance.

21. The non-transitory computer-readable medium of claim 15, wherein the user input is a virtual character model of a second virtual character, and the modification of the game attribute includes adding the virtual character model of the second virtual character to a library of models introducible into the virtual environment.
